(19) United States
(12) Patent Application Publication
(10) Pub. No.: US 2014/0272826 A1
(43) Pub. Date: Sep. 18, 2014

(54) SYSTEM AND METHOD FOR TARGETED STRENGTHENING OF BRAIN NETWORKS FOR FLUENT READING ACQUISITION

(71) Applicant: The Carroll School, Lincoln, MA (US)

(72) Inventors: Stephen M. Wilkins, Lincoln, MA (US); Eric Falke, Medford, MA (US); Benjamin Shepard, Somerville, MA (US)

(73) Assignee: The Carroll School, Lincoln, MA (US)

(21) Appl. No.: 14/213,628

(22) Filed: Mar. 14, 2014

Related U.S. Application Data
(60) Provisional application No. 61/789,873, filed on Mar. 15, 2013.

(51) Int. Cl. G09B 17/04

(52) U.S. Cl. CPC G09B 17/04
USPC 434/178

(57) ABSTRACT

Systems and methods for targeted strengthening of brain networks for fluent reading acquisition are provided. A task is delivered to assess neuronal connectivity of working-memory-network areas of a brain of a subject. Weaknesses in neuronal connectivity between working-memory-network areas of the brain are identified based on the assessment. Based on the identified weaknesses, a training exercise is delivered to the subject to increase neuronal connectivity between the identified working-memory-network areas of the brain of the subject.

### BACKGROUND

Typical readers have intact working memory comprised of largely separate and parallel processing streams for visuo-spatial, verbal, and visual feature information. As shown in FIG. 1A, each “stream” is comprised of unique posterior areas which function as short-term stores for visuo-spatial (horizontal intraparietal sulcus), verbal (Wernicke's area), and visual feature (visual-word form area) short-term memory linked via specific white matter tracts to the executive functions of the prefrontal cortex and cingulate cortex (in particular the dorsal lateral prefrontal cortex and left inferior frontal gyms). Connectivity via white matter tracts is depicted as arrows 102 The prefrontal cortex is linked to visual, verbal, and spatial short-term stores. In addition to parallel sensory specific streams running anterior-posterior, the temporparietal junction which includes the left inferior parietal lobule is another important association area for visual, verbal, and auditory sequences. FIG. 1B (taken from Zeynep M. Saygin, Elizabeth S. Norton, David E. Osher, Sara D. Beach, Abigail B. Cyr, Ola Ozemov-Palchik, Anastasia Yendiki, Bruce Fischl, Nadine Gaab, and John D. E. Gabrieli. Tracking the Roots of Reading Ability: White Matter Volume and Integrity Correlate with Phonological Awareness in Prereading and Early-Reading Kindergarten Children. Journal of Neuroscience. August 14, 2013. 33(33):13251-13258) depicts white matter tracts 104 connecting working memory network areas of the brain as observed by diffusion magnetic resonance imaging (MRI). According to the current understanding in the field, this linking between short-term memories allows the alphabetic code of written language words to be deciphered. A direct link between verbal short-term memory and visuo-spatial memory in the left-sided temporoparietal junction has been shown. In beginning readers, there is no direct link between visual feature and verbal short-term stores; these are indirectly linked via the prefrontal executive. In order to achieve a fluent reading circuit, neuronal connectivity that directly links the visual feature store to verbal short-term and visuo-spatial stores must be robust.

### SUMMARY

Approximately 70% of dyslexics have known weaknesses in working memory. Internal Carroll School research conducted over the last 2 years in over 400 students indicates that groups of students struggle with different components and connections within the working memory network. Individual students may struggle with either visuo-spatial or verbal working memory skills. Other students have global executive function problems.

The brain basis of each of the distinct elements of the left-sided working memory network is structurally different in groups of children with language-based learning disabilities. Abnormal left-sided temporoparietal structure is common in pre-reading relatives of dyslexics. This area is key to verbal and visuo-spatial short memory and their integration. In addition, pre-school age children who go on to develop dyslexia have thinner and less well organized white matter tracts linking prefrontal and short-term memory stores. Finally, lack of activation of left temporoparietal verbal, visuo-spatial, and visual word form (visual feature) areas when reading is a key difference between dyslexic and typical readers. This is a major target of remediation in the present systems and methods for targeted strengthening of brain networks for fluent reading acquisition.

The systems and methods for targeted strengthening of brain networks for fluent reading acquisition disclosed here emerge from a novel synthesis of contemporary neuroscience research on both typical and atypical reading acquisition. A widespread consensus has emerged that the brain basis of typical fluent reading acquisition depends on the creation of a new brain network centered on the temporoparietal area in the left hemisphere which directly links visual feature, verbal, and visuo-spatial processing at the temporoparietal junction. This is the first targeted training program that intentionally recreates key components and connections of the typical reading circuit via targeted strengthening of brain networks for fluent reading acquisition.

One of the key features of the early reading circuit is that it significantly overlaps in its components and connections with that of the working memory network. The systems and methods for targeted strengthening of brain networks for fluent reading acquisition make use of this overlap between the brain basis of working memory and the brain basis of reading in several ways. In general, a functional and complete working memory network is necessary for the acquisition of fluent comprehending reading. Therefore a sequence of instruction emerges in which many aspects of the working memory network are remediated. Subsequent to the remediation of the working memory network a method for the step-wise construction of a typical fluent reading circuit is provided.

Assessments to profile components of the working memory network not currently measured in neuropsychology are developed. These components include visual feature memory (commonly referred to as the ventral stream of visual processing) and the direct linking between visuo-spatial, verbal, and visual feature streams of information so critical for fluent reading's development. Automatized, fluent reading requires substantially less prefrontal executive effort than fluent reading because it relies on a circuit that does not require the prefrontal cortex to mediate multi-sensory binding. The fluent reading circuit allows readers to deploy limited working memory and executive function resources for reading comprehension instead of effortful decoding.

An emerging body of research has suggested that some of the executive functions and components of the working memory network such as visuo-spatial and verbal working memory can be remediated via computer-based training. This is the first attempt to remediate all components and connections within the working memory network outlined above as well as the functional connectivity between them that develops following years of reading experience in typical readers. Novel systems and methods are introduced to remediate visual feature memory and the links among executive functions, visuo-spatial, verbal, and visual feature short-term memory stores.

This remediation will improve what are generally considered to be co-morbid associations with language-based learning disabilities including but not limited to expressive and receptive language problems, dyscalculia, dysgraphia, inattentive symptoms of ADHD, and common executive function problems. Due to their overlapping brain basis: common psychological problems casually related to low reading fluency including working memory, processing speed, slow and inconsistent response and continuous performance tests will also be remediated. Specific executive functions likely to improve from the program include: inhibition, task switching, maintaining information in working memory in defense of distraction, multi-modal binding, long-term memory encoding of novel information and retrieval of information from long-term memory. Specific kinds of attention likely to benefit from the program include all those described by Posner including alerting, orienting, executive control, emotional self-regualtion. (see Petersen S. E., Posner M. I. The Attention System of the Human Brain: 20 Years After. Annual Review of Neuroscience. 35:73-89 (2012))

A computer-based system for targeted strengthening of brain networks for fluent reading acquisition includes retrieving, by one or more processors, a task from a memory element. The task is delivered by one or more processors to assess neuronal connectivity of working-memory-network areas of a brain of a subject. One or more processors receive responses to the task from the subject and convert the responses into a score. Weaknesses in neuronal connectivity between working-memory-network areas of the brain are identified by one or more processors based on the score. Based on the identified weaknesses, selection of a training exercise is carried out by one or more processors. The training exercise is retrieved by one or more processors from a memory element and the training exercise is delivered by one or more processors to increase neuronal connectivity between the working-memory-network areas of the brain of the subject with identified weaknesses.

A method for targeted strengthening of brain networks for fluent reading acquisition includes delivering an assessment task to a subject to assess neuronal connectivity of working-memory-network areas of a brain of the subject. Weaknesses in the neuronal connectivity between working-memory-network areas of the brain are identified based on the assessment. A training exercise is selected based on the identified weaknesses and the training exercise is delivered to the subject to increase neuronal connectivity between the identified working-memory-network areas of the brain.

### BRIEF DESCRIPTION OF THE DRAWINGS

FIG. 1A depicts a side view of the brain and depicts connectivity and working memory network in the Brain.

FIG. 1B depicts a diffusion MRI image with reconstructed white matter tracts in the brain. (taken from Zeynep M. Saygin, Elizabeth S. Norton, David E. Osher, Sara D. Beach, Abigail B. Cyr, Ola Ozernov-Palchik, Anastasia Yendiki, Bruce Fischl, Nadine Gaab, and John D. E. Gabrieli. Tracking the Roots of Reading Ability: White Matter Volume and Integrity Correlate with Phonological Awareness in Prereading and Early-Reading Kindergarten Children. Journal of Neuroscience. Aug. 14, 2013. 33(33):13251-13258)

FIG. 2A depicts graphs of fractional anisotropy and white matter volume for targeted tracts in relation to scores in assessments. (taken from Zeynep M. Saygin, Elizabeth S. Norton, David E. Osher, Sara D. Beach, Abigail B. Cyr, Ola Ozernov-Palchik, Anastasia Yendiki, Bruce Fischl, Nadine Gaab, and John D. E. Gabrieli. Tracking the Roots of Reading Ability: White Matter Volume and Integrity Correlate with Phonological Awareness in Prereading and Early-Reading Kindergarten Children. Journal of Neuroscience. Aug. 14, 2013. 33(33):13251-13258)

FIG. 2B depicts representations of brains depicting areas of changed white matter structure in response to training. (taken from Allyson P. Mackey, Kirstie J. Whitaker and Silvia A. Bunge. Experience-dependent plasticity in white matter microstructure: reasoning training alters structural connectivity. Frontiers in Neuroanatomy. Aug. 2012 6: 32: 1-9)

FIG. 3 depicts a flow chart depicting a system for targeted strengthening of brain networks for fluent reading acquisition.

FIG. 4A depicts an example of a 2-dimensional grid task

FIG. 4B depicts an example of a 2-dimensional grid task.

FIG. 5 depicts a flowchart depicting the method for targeted strengthening of brain networks for fluent reading acquisition.

### DETAILED DESCRIPTION

One of the key features of the early reading circuit is that it significantly overlaps in its components and connections with that of the working memory network. This overlap between the brain basis working memory and the brain basis of reading is utilized. In general, a functional and complete working memory network is presumed to be necessary for fluent comprehending reading. Therefore a sequence of instruction emerges in which many aspects of the working memory network are remediated prior to reading instruction. A sequential and individualized program of existing techniques are employed in combination with novel techniques designed to reconstruct a typical fluent reading circuit in a stepwise manner.

The working memory network is associated with certain areas of the brain as shown by functional imaging studies and supported by observation of subjects with localized damage, weakness, degeneration in the brain as well as by trans-cranial magnetic stimulation studies that selectively and temporarily impair targeted areas of the brain. The Dorsal Lateral Prefrontal Cortex, Broca's area, anterior cingulate gyms and the temporparietal junction have been identified as critical areas of executive function in the working memory network. Because the working memory network overlaps substantially with the early reading circuit, its components are the targets of the systems and methods for targeted strengthening of brain networks for fluent reading acquisition. In addition the brain basis of working memory substantially overlaps with that of other cognitive skills which are frequently weak in children with language based learning disabilities these include slow processing speed, slow reaction time, several executive functions and types of attention.

A major goal of assessment is to comprehensively profile the diverse cognitive skills required for the acquisition of fluent reading with comprehension in people ranging from ages 5-21 years old. These skills include executive functions, attention, oral language skills, processing speed, simple and complex reaction time, multi-modal binding, and the central executive, visual, spatial, and verbal components of working memory. Currently, it requires multiple tests to match learner profiles to specific cognitive training interventions. The process of integrated assessment for dyslexic students may be streamlined by a tool for formative assessment. This tool will require less testing time and be normed for repeated measures in a language-based learning disability population.

Current, paper based assessments are not consistent from student to student because they are administered by a diverse group of community practitioners and cannot be administered by school faculty in a group setting. This lack of standardization makes it difficult to integrate information on how a child learns and what to do for that child in the classroom. The high cost of contemporary cognitive assessment makes repeated testing impractical and makes it challenging to measure the impact of cognitive training interventions and to implement a sequence of targeted cognitive instruction. In addition, current methods employ a broad approach to cognitive training and do not specifically target neuronal connectivity in specific areas of the brain. Targeted strengthening allows specific construction and remediation of brain networks required for reading fluency that do not develop without training.

The Carroll School (Lincoln, Mass.) undertook research initiative to profile the working memory system in nearly 400 students with language-based learning disabilities. The project uses multiple, psychological tests designed to look at verbal, visuo-spatial and executive components of working memory. It was found that while the vast majority of Carroll students have weaknesses in the working memory network, their specific areas of weakness differ. Some students have problems with verbal memory, others have trouble with visuo-spatial memory. In addition, some students have trouble with the executive functions believed to be critical for learning new links between visual and verbal information. Assessments may be designed to evaluate: 1) visual feature, verbal, and spatial short-term memory storage capacity under both timed and untimed conditions; 2) visual, verbal, and spatial working memory capacity; 3) processing speed/reaction time (both simple and complex) for the visual, verbal, and spatial streams (with a strong emphasis on uncoupling speed measures from short-term memory capacity), 4) multi-sensory binding capacity and speed among visual, verbal, spatial streams. An important innovation will be to distinguish between working memory tasks requiring the manipulation of sequences that are highly dependent on temporparietal association areas and other types of manipulation such as defense from distraction and shifting attention. 5) Specific executive functions including: inhibition, task switching, maintaining information in working memory in defense of distraction, multi-modal binding, long-term memory encoding of novel information, and retrieval of information from long-term memory. 6) Specific kinds of attention include all those described by Posner including alerting, orienting, executive control, emotional self-regulation.

Systems and methods for targeted strengthening of brain networks for fluent reading acquisition are designed to strengthen critical components and connections within the brain network required for the acquisition of fluent comprehending reading. Using tasks to make assessments, weaknesses with perceptual categorization or short-term memory stores may be identified. These may be remediated first. The next stage may target weaknesses in specific sensory streams of working memory. Multi-modal integration may be the fourth target and may initially focus on storage and manipulation of conjunctions between sensory information i.e. auditory-spatial, visual-auditory. The final stage of targeted strengthening of brain networks may target specific core executive functions including cognitive flexibility, inhibition, and interference control and other specific kinds of attention including alerting, orienting, executive, and self-regulatory skills (Petersen S. E., Posner M. I. The Attention System of the Human Brain: 20 Years After. Annual Review of Neuroscience. 35:73-89 (2012)).

FIG. 2A depicts, on the left panel, a graph of white matter volume in targeted areas as it correlates to a Blending Word score 210. The Blending Word score is a score obtained by combination of three different assessment tasks performed by a range of subjects. Figure taken from Saygin 2013 (Zeynep M. Saygin, Elizabeth S. Norton, David E. Osher, Sara D. Beach, Abigail B. Cyr, Ola Ozernov-Palchik, Anastasia Yendiki, Bruce Fischl, Nadine Gaab, and John D. E. Gabrieli. Tracking the Roots of Reading Ability: White Matter Volume and Integrity Correlate with Phonological Awareness in Prereading and Early-Reading Kindergarten Children. Journal of Neuroscience. Aug. 14, 2013. 33(33:13251-13258). Also depicted in FIG. 2A, in the right panel, a graph of fractional anisotropy, a tissue property indicating directionality of fiber tracts and robust neuronal connectivity, in targeted areas as it correlates to a Blending Word score 210. Functions 212 are fit to the observed trend of increasing volume and fractional anisotropy of white matter in targeted areas. This data shows a correlation between increased neuronal connectivity and score resulting from assessment tasks performed by human subjects.

FIG. 2B depicts a change in neuronal connectivity in response to training. In FIG. 2B, radial diffusion (RD) and mean diffusion (MD) are used as metrics for robustness of neuronal connectivity. As both RD and MD are widely agreed to be inversely proportional to organization or strength of neuronal connectivity, a decrease in RD or MD signifies a strengthening of neuronal connectivity. This Figure is taken from Mackey 2012 (Allyson P. Mackey, Kirstie J. Whitaker and Silvia A. Bunge. Experience-dependent plasticity in white matter microstructure: reasoning training alters structural connectivity. Frontiers in Neuroanatomy. Aug. 2012 6: 32: 1-9), where a standardized test was given to subjects before and after training. Structural changes and increases in connectivity have been observed and characterized in response to training. Images of the brain are depicted 216 with highlighted areas 218 identifying areas of changed neuronal structure. This increase in connectivity differs from the normal increase that may be observed in subjects as it is specifically induced by the type of training delivered to the subject. In the case of FIG. 1C the subjects received training on a standardized test and the test was delivered before and after the training. The graphs in the panel 214 depict the observed decreases in radial and mean diffusion.

Referring to FIG. 3, and in brief overview, a system for targeted strengthening of brain networks for fluent reading acquisition includes retrieving, by one or more processors 306, a task 302 from a memory element 304. The task 302 is delivered by one or more processors 306 to assess neuronal connectivity of working-memory-network areas of a brain of a subject 305. One or more processors receive responses to the task from the subject and convert the responses into a score. Weaknesses in neuronal connectivity between working-memory-network areas of the brain are identified by one or more processors 306 based on the score. Based on the identified weaknesses, selection of a training exercise 308 is carried out by one or more processors 306. The training exercise 308 is retrieved by one or more processors 306 from a memory element 304′ and the training exercise 308 is delivered by one or more processors 306 to increase neuronal connectivity between the working-memory-network areas of the brain of the subject 305 with identified weaknesses. In some embodiments, scores may be stored in a database 310 of responses and scores. In some other embodiments, a task 302 may be delivered via a user interface 309. Responses to tasks may be received via a user interface. In some embodiments, a training exercise 308 may be delivered via a user interface 309. In some embodiments the one or more processors 306 may be associated with a network 382. A task 388 may be stored in a memory element in the network 382. In some embodiments, the exercise 386 may be in a memory element in the network 382. In some embodiments, the database 384 of responses and scores may be in a memory element in the network 392.

Still referring to FIG. 3, in some embodiments, the system for targeted strengthening of brain networks for fluent reading acquisition includes retrieving, by one or more processors, a task 302 from a memory element 304. The task is delivered by one or more processors 306 to assess neuronal connectivity of working-memory-network areas of a brain of a subject 305. One or more processors 306 receive responses to the task from the subject 305 and convert the responses into a score. Weaknesses in neuronal connectivity between working-memory-network areas of the brain are identified by one or more processors 306 based on the score. Based on the identified weaknesses, selection of a training exercise 308 is carried out by one or more processors 306. The training exercise 308 is retrieved by one or more processors 306 from a memory element 304′ and the training exercise is delivered by one or more processors 306 to increase neuronal connectivity between the working-memory-network areas of the brain of the subject 305 with identified weaknesses. In some embodiments, scores may be stored in a database 310 of responses and scores contained in a memory element 304″. The one or more processors 306 may be associated with a network 382.

Still referring to FIG. 3, in some embodiments, the system for targeted strengthening of brain networks for fluent reading acquisition includes retrieving, by one or more processors 316, a task 312 from a memory element 314. The task 312 is delivered by one or more processors 316 to assess neuronal connectivity of working-memory-network areas of a brain of a subject 315. One or more processors 316 receive responses to the task from the subject 315 and convert the responses into a score. Weaknesses in neuronal connectivity between working-memory-network areas of the brain are identified by one or more processors 316 based on the score. Based on the identified weaknesses, selection of a training exercise 318 is carried out by one or more processors 316. The training exercise 318 is retrieved by one or more processors 316 from a memory element 314′ and the training exercise 318 is delivered by one or more processors 316 to increase neuronal connectivity between the working-memory-network areas of the brain of the subject 315 with identified weaknesses. The one or more processors are associated with a network 382. In some embodiments, scores may be stored in a database 310 of responses and scores contained in the network 382.

Still referring to FIG. 3, in some embodiments, the system for targeted strengthening of brain networks for fluent reading acquisition includes retrieving, by one or more processors 326 associated with a network 382, a task 322 from a memory element 324. The task is delivered by one or more processors 326 to assess neuronal connectivity of working-memory-network areas of a brain of a subject. One or more processors receive responses to the task from the subject 325 and convert the responses into a score. Weaknesses in neuronal connectivity between working-memory-network areas of the brain are identified by one or more processors 326 based on the score. Based on the identified weaknesses, selection of a training exercise 386 is carried out by one or more processors 326. The training exercise 386 is retrieved by one or more processors 326 from the network 382 and the training exercise 386 is delivered by one or more processors 326 to increase neuronal connectivity between the working-memory-network areas of the brain of the subject with identified weaknesses. In some embodiments, scores may be stored in a database 330 of responses and scores contained in a memory element 324″.

Still referring to FIG. 3, in some embodiments, the system for targeted strengthening of brain networks for fluent reading acquisition includes retrieving, by one or more processors 336 associated with a network 382, a task 332 from a memory element 334. The task 332 is delivered by one or more processors 336 to assess neuronal connectivity of working-memory-network areas of a brain of a subject 335. One or more processors 336 receive responses to the task 332 from the subject 335 and convert the responses into a score. Weaknesses in neuronal connectivity between working-memory-network areas of the brain are identified by one or more processors 336 based on the score. Based on the identified weaknesses, selection of a training exercise 386 is carried out by one or more processors 336. The training exercise 386 is retrieved by one or more processors from the network 382 and the training exercise 386 is delivered by one or more processors 336 to increase neuronal connectivity between the working-memory-network areas of the brain of the subject 335 with identified weaknesses. In some embodiments, scores may be stored in a database 384 of responses and scores contained in a network 382.

Still referring to FIG. 3, in some embodiments, the system for targeted strengthening of brain networks for fluent reading acquisition includes retrieving, by one or more processors 346 associated with a network 382, a task 388 from the network 382. The task 388 is delivered by one or more processors 346 to assess neuronal connectivity of working-memory-network areas of a brain of a subject 345. One or more processors 346 receive responses to the task 388 from the subject 345 and convert the responses into a score. Weaknesses in neuronal connectivity between working-memory-network areas of the brain are identified by one or more processors 346 based on the score. Based on the identified weaknesses, selection of a training exercise 348 is carried out by one or more processors 346. The training exercise is retrieved by one or more processors 346 from a memory element 344 and the training exercise is delivered by one or more processors 346 to increase neuronal connectivity between the working-memory-network areas of the brain of the subject with identified weaknesses. In some embodiments the training exercise 348 is delivered via a user interface 349. In some embodiments, scores may be stored in a database 350 of responses and scores contained in a memory element 344′.

Still referring to FIG. 3, in some embodiments, the system for targeted strengthening of brain networks for fluent reading acquisition includes retrieving, by one or more processors 356 associated with a network 382, a task 388 from the network 382. The task 388 is delivered by one or more processors 356 to assess neuronal connectivity of working-memory-network areas of a brain of a subject 355. One or more processors 356 receive responses to the task 388 from the subject 355 and convert the responses into a score. Weaknesses in neuronal connectivity between working-memory-network areas of the brain are identified by one or more processors 356 based on the score. Based on the identified weaknesses, selection of a training exercise 386 is carried out by one or more processors 356. The training exercise 386 is retrieved by one or more processors from the network 382 and the training exercise 386 is delivered by one or more processors 356 to increase neuronal connectivity between the working-memory-network areas of the brain of the subject 355 with identified weaknesses. In some embodiments the training exercise 386 is delivered via a user interface 359. In some embodiments, scores may be stored in a database 360 of responses and scores contained in a memory element 354.

Still referring to FIG. 3, in some embodiments, the system for targeted strengthening of brain networks for fluent reading acquisition includes retrieving, by one or more processors 366 associated with a network 382, a task 388 from the network 382. The task 388 is delivered by one or more processors 366 to assess neuronal connectivity of working-memory-network areas of a brain of a subject 365. One or more processors 366 receive responses to the task 388 from the subject and convert the responses into a score. Weaknesses in neuronal connectivity between working-memory-network areas of the brain are identified by one or more processors 366 based on the score. Based on the identified weaknesses, selection of a training exercise 368 is carried out by one or more processors 366. The training exercise 368 is retrieved by one or more processors from a memory element 364 and the training exercise is delivered by one or more processors 366 to increase neuronal connectivity between the working-memory-network areas of the brain of the subject 365 with identified weaknesses. In some embodiments the training exercise 368 is delivered via a user interface 369. In some embodiments, scores may be stored in a database 384 of responses and scores contained in the network 382.

Still referring to FIG. 3, in some embodiments, the system for targeted strengthening of brain networks for fluent reading acquisition includes retrieving, by one or more processors 376 associated with a network 382, a task 388 from the network 382. The task is delivered by one or more processors 376 to assess neuronal connectivity of working-memory-network areas of a brain of a subject 375. One or more processors 376 receive responses to the task from the subject 375 and convert the responses into a score. Weaknesses in neuronal connectivity between working-memory-network areas of the brain are identified by one or more processors 376 based on the score. Based on the identified weaknesses, selection of a training exercise 386 is carried out by one or more processors 376. The training exercise 386 is retrieved by one or more processors 376 from the network 382 and the training exercise 386 is delivered by one or more processors 376 to increase neuronal connectivity between the working-memory-network areas of the brain of the subject 375 with identified weaknesses. In some embodiments the training exercise is delivered via a user interface 379. In some embodiments, scores may be stored in a database 384 of responses and scores contained in the network 382.

The one or more processors may include a microprocessor, an application-specific integrated circuit (ASIC), a field-programmable gate array (FPGA), etc., or combinations thereof.

A memory element may include, but is not limited to, electronic, optical, magnetic, or any other storage or transmission device capable of providing processor with program instructions. The memory element may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which a processor can read instructions.

In some embodiments, the one or more processors may be associated with least one computer network such as the network 382. The network may include a local area network (LAN), wide area network (WAN), a telephone network, such as the Public Switched Telephone Network (PSTN), a wireless link, an intranet, the Internet, or combinations thereof.

(tasks 302, 312, 322, 332 and 388 shall hereinafter be referred to as task 302

In some embodiments, the task 302 may target a single area, multiple areas, short term stores, or connectivity between multiple areas. In some embodiments, the task 302 may require the subject to recall or react to cues like symbols, letters, sounds or 2-dimensional locations. The task 302 may combine types of cues like sounds, shapes, symbols or locations with each other. The task 302 may require the subject to associate certain cues with others. The task 302 may be directed toward assessing the subject's ability to perceptually categorize stimuli that have been presented to them. The task 302 may also assess the subject's reaction time, measuring the subject's temporal response to the presentation of a stimulus. In some embodiments, the task 302 may require the subject to push a button upon receiving a specified stimulus. The stimulus, in this case, may be any above-described cue or combination thereof. The task 302 may be grid-based to specify locations in a 2-dimensional space. In some embodiments, the task 302 may be a symbol-digit coding task 302, in which the subject is prompted to observe and react to mapping of written symbols to a numerical code.

In some embodiments, the task 302 may be a visuo-spatial, an example of which is shown in FIG. 4A. The task 302 may display a 2-dimensional grid 410 with multiple locations 420. In some embodiments the task 302 may include symbols or letters 430 in locations 420 on the grid 410. Referring to FIG. 4B, in some embodiments, the task 302 may be a sound-visuo-spatial grid task 302. Phonemes 470 may be presented auditorially or visually in locations 460 on a 2-dimensional grid 450. In some embodiments, the task 302 may associate phonemes with locations 470 and further may associate symbols or letters 420 with the same or different locations 410 and with phonemes 470.

In some embodiments, the task 302 may be delivered as a game or in the context of a game. In some embodiments, a task 302 may assess neuronal connectivity in a subject's brain and may assess different cognitive processes that are associated with different areas of the brain. Weaknesses in such cognitive processes are correlated with weaknesses in specific areas of the brain and neuronal connectivity thereof.

In some such embodiments, a task 302 may assess verbal short-term memory. One example of a verbal short-term memory assessment task 302 is a forward digit span task, where a series of digits, symbols, phonemes or other cues are presented to a subject verbally, visually or auditorially and the subject is instructed to recall the cues in the order presented.

In some other embodiments, a task 302 may assess verbal working memory. One example of a verbal working memory assessment task is a backward digit span task, where a series of digits, symbols, phonemes or other cues are presented to a subject verbally, visually or auditorially and the subject is instructed to recall the cues in the opposite order to the order that they were presented.

In some other embodiments, a task 302 may assess processing speed. One example of a processing speed assessment task is a symbol digit coding task in which a series of symbols are presented to a subject in correlation with specific digits. The subject is then presented symbols alone and instructed to indicate the digits that were presented in correlation with the specific symbols.

In some other embodiments, a task 302 may assess executive function. One example of an executive function assessment task is a shifting attention test in which multiple cues, for example, geometric shapes of different colors, are presented to a subject. The subject is instructed to match cues in accordance with different features, for example, shape or color. The instructions may change throughout the task.

In some other embodiments, a task 302 may assess psychomotor speed. One example of a psychomotor speed assessment task is a finger tapping test in which a subject is instructed to push a button, tap their finger or perform another task as many times as they can in a specified amount of time.

A task 302 may be presented in the form of a game. In some embodiments, a cue may be presented in the form of a variation on an object, symbol or sound from other presented objects, symbols or sounds. One example of such a variation is displaying the cue in a different color to differentiate from other objects or images displayed. In some embodiments, the cue may appear to have a different characteristic, different color, symbol, sound or other feature than other objects, images, sounds presented in the task. The subject may be instructed to perform a specific task in response to being presented a cue. In some embodiments, the subject may be instructed to push a button or click on an image or symbol in a computer displayed user interface in response to the presence of a specified cue. An example may include displaying a group of objects that are the same color and instructing the subject to push a button when an object of a different color is displayed, then displaying a group of objects all having the same color except for one more that are displayed in a different color. In some embodiments the subject may be instructed to recall an order of events that occurred during the task. An example includes displaying a series of objects to the subject where a number of the objects change color, then instructing the subject to recall the objects that changed color in a specific order (the same order as it appeared or backwards. In some embodiments, positive reinforcement may be provided to the subject in response to completion of a task 302. In some such embodiments, positive reinforcement may include encouraging statements or in the form of points or other value within the context of a game.

In some embodiments, the subject's responses or results from the task may be stored in a database. The results of the task 302 may be organized in a database to form a profile of the subject. The profile of the subject may include information about the subject's age or other demographic information that would allow the profiles of a plurality of subjects to be categorized. In some embodiments, where the systems and methods for targeted strengthening of brain networks for fluent reading acquisition may be implemented in a school, the profiles of subjects may be grouped by grade, age, class or other characteristic.

In some embodiments, the task 302 may be scored. The task 302 may be scored on a numerical scale. A database of responses to the various assessment tasks may be generated using previous results from the subject or other subjects with a range of reading fluencies and neuronal connectivities between working memory network areas of the brain. The database may associate fluency in reading and neuronal connectivity with a range of scores for the assessment tasks. The subject's performance in a task 302 may be scored and compared to a database of scores and responses. The subject's scores may be correlated with relative strength of the neuronal connectivity of the working memory network areas of the brain. In some embodiments scores may be correlated with neuronal connectivity by comparing the subject's score in a task 302 to scores in the database.

Referring back to FIG. 3, weaknesses in the neuronal connectivity of the working memory network areas of the subject's brain may be identified by comparing the score of the assessment task 302 to a database of scores. In some other embodiments identifying weaknesses may include comparing the subject's responses to the task 302 to the responses of one or more other subjects. In some embodiments, identifying weaknesses may include comparing the subject's responses to the task 302 to one or more models of responses. Identifying weaknesses can include comparing the subject's responses to the task 302 to a set of known responses that may be associated with different connectivities. In some embodiments, weaknesses in the neuronal connectivity of the working memory network areas of the subject's brain may be identified by comparison of scores to a model of scores that correlates neuronal connectivity. In some such embodiments a model may be generated by fitting a function to observed trends of white matter volume, observed anisotropy of diffusion in neurons or other measurement of structural characteristic of neurons in relation to scores.

Selecting a training exercise may include selecting a training exercise that targets remediation of the areas of the brain, or connectivities thereof, where weaknesses were identified. Selecting a training exercise may include selecting a combination or group of training exercises. Training exercises may be categorized by the areas of the brain that they strengthen neuronal connectivity of. A training exercise may be selected based on the area of the brain that the training exercise is categorized to strengthen neuronal connectivity of and where weakness was identified. In some embodiments, selecting a training exercise may be automated and performed by an electronic computing device.

In some embodiments, the training exercise may target a single area, multiple areas, short term stores, or connectivity between multiple areas. In some embodiments, the training exercise may require the subject to recall or react to cues like symbols, letters, sounds or 2-dimensional locations. The training exercise may combine types of cues like sounds, shapes, symbols or locations with each other. The training exercise may require the subject to associate certain cues with others. The training exercise may be directed toward training the subject's ability to perceptually categorize stimuli that have been presented to them. The training exercise may also train the subject's reaction time. In some embodiments, the training exercise may require the subject to push a button upon receiving a specified stimulus. The stimulus, in this case, may be any above-described cue or combination thereof. The training exercise may be grid-based to specify locations in a 2-dimensional space. In some embodiments, the training exercise may be a symbol-digit coding exercise, in which the subject is prompted to observe and react to one or more patterns of digits. In some embodiments, spatial distribution of stimuli is not achieved through display on a grid alone but may also feature moving stimuli or specifically ordered stimuli. Training exercises may be presented in the same format as some assessment tasks. In some embodiments, training exercises may target cognitive processes that are associated with strengthening connectivities in specific areas of the brain, such as verbal short-term memory, verbal working memory, processing speed, executive function, psychomotor speed, sustained attention and cognitive flexibility. Training exercises may deliver a stimulus for which frequency of presentation, duration and number of stimuli may be systematically increased. Training exercises may be multi-modal, strengthening neuronal connectivity in multiple areas of the brain by combining cognitive processes that they target.

In some embodiments, training exercises strengthen neuronal connectivity in areas of the brain that are associated with specific cognitive processes. Some examples of such cognitive processes include verbal-short-term memory, verbal working memory, processing speed, executive function, psychomotor speed, response time, sustained attention, cognitive flexibility and reasoning.

Training exercises may be generated by determining tasks that improve cognitive processes specifically associated with neuronal connectivities of areas of the brain involved in the working memory network.

In some implementations, positive reinforcement may be delivered to the subject upon completion of a training exercise. Positive reinforcement may be delivered in the form of encouraging statements or in the form of points or other value within the context of a game.

Referring now to FIG. 5, and in brief overview, a method for targeted strengthening of brain networks for fluent reading acquisition begins with delivering a task to a subject to assess neuronal connectivity of working-memory-network areas of a brain of the subject (step 502). The method further includes identifying weaknesses in the neuronal connectivity between working-memory-network areas of the brain based on the assessment (step 504), selecting a training exercise based on the identified weaknesses (step 506) and delivering the training exercise to the subject to increase neuronal connectivity between the identified working-memory-network areas (step 508).

Still referring to FIG. 5, and in greater detail, the task may be delivered (step 502) as a game or in the context of a game. In some embodiments, the task may be delivered (step 502) via an electronic computing device. In some of these embodiments, the task may be delivered (step 502) via tablet computing device, such as the IPAD (manufactured by Apple, Inc. of Cupertino, Calif.) or the MICROSOFT SURFACE (manufactured by Microsoft Corporation or Seattle, Wash.). In other embodiments, the task may be delivered (step 502) via electronic gaming console. In some embodiments, the task may be delivered in series with other tasks.

In some embodiments, the task may target a single area, multiple areas, short term stores, or connectivity between multiple areas. In some embodiments, the task may require the subject to recall or react to cues like symbols, letters, sounds or 2-dimensional locations. The task may combine types of cues like sounds, shapes, symbols or locations with each other. The task may require the subject to associate certain cues with others. The task may be directed toward assessing the subject's ability to perceptually categorize stimuli that have been presented to them. The task may also assess the subject's reaction time, measuring the subject's temporal response to the presentation of a stimulus. In some embodiments, the task may require the subject to push a button upon receiving a specified stimulus. The stimulus, in this case, may be any above-described cue or combination thereof. The task may be grid-based to specify locations in a 2-dimensional space.

In some embodiments, the task may be a visuo-spatial as shown in FIG. 4A. The task may display a 2-dimensional grid 410 with multiple locations 420. In some embodiments the task may include symbols or letters 430 in locations 420 on the grid 410. Referring to FIG. 4B, in some embodiments, the task may be a sound-visuo-spatial grid task. Phonemes 470 may be presented auditorially or visually in locations 460 on a 2-dimensional grid 450. In some embodiments, the task may associate phonemes with locations 470 and further may associate symbols or letters 420 with the same or different locations 410 and with phonemes 470.

In some embodiments, delivering a task to assess neuronal connectivity in a subject's brain (step 502) may include delivering a task to assess different cognitive processes that are associated with different areas of the brain. Weaknesses in such cognitive processes are correlated with weaknesses in specific areas of the brain and neuronal connectivity thereof.

In some such embodiments, a task may be delivered (step 502) to assess verbal short-term memory. One example of a verbal short-term memory assessment task is a forward digit span task, where a series of digits, symbols, phonemes or other cues are presented to a subject verbally, visually or auditorially and the subject is instructed to recall the cues in the order presented.

In some other embodiments, a task may be delivered (step 502) to assess verbal working memory. One example of a verbal working memory assessment task is a backward digit span task, where a series of digits, symbols, phonemes or other cues are presented to a subject verbally, visually or auditorially and the subject is instructed to recall the cues in the opposite order to the order that they were presented.

In some other embodiments, a task may be delivered (step 502) to assess processing speed. One example of a processing speed assessment task is a symbol digit coding task in which a series of symbols are presented to a subject in correlation with specific digits. The subject is then presented symbols alone and instructed to indicate the digits that were presented in correlation with the specific symbols.

In some other embodiments, a task may be delivered (step 502) to assess executive function. One example of an executive function assessment task is a shifting attention test in which multiple cues, for example, geometric shapes of different colors, are presented to a subject. The subject is instructed to match cues in accordance with different features, for example, shape or color. The instructions may change throughout the task.

In some other embodiments, a task may be delivered (step 502) to assess psychomotor speed. One example of a psychomotor speed assessment task is a finger tapping test in which a subject is instructed to push a button, tap their finger or perform another task as many times as they can in a specified amount of time.

One example of an assessment task is a Stroop test. A Stroop includes the presentation of the words for different colors, for example, the words RED, YELLOW, BLUE, and GREEN (printed in black) are presented. The subject is instructed to press a button as soon as they see the word. The words for different colors are presented in various colors, for example, the words RED, YELLOW, BLUE, and GREEN are presented, in BLUE, BLUE, BLUE, and GREEN respectively. The subject is instructed to press a button when the color that word is presented in matches the color that the word describes. The words for different colors are presented in various colors, for example, the words RED, YELLOW, BLUE, and GREEN are presented, printed in YELLOW, BLUE, BLUE and GREEN. The subject is instructed to press a button when the color that the word is printed in does not match the color that the word describes.

In some embodiments, delivering a task to assess neuronal connectivity of working-memory-network areas of the brain (step 502) may include delivering commercially available assessment tasks including tasks from assessment and cognitive suites from CNS VITAL SIGNS (Morrisville, N.C.), COGNIMED (Livingston, N.J.), POSIT SCIENCE (San Francisco, Calif.), or other sources.

A task may be presented in the form of a game. In some embodiments, a cue may be presented in the form of a variation on an object, symbol or sound from other presented objects, symbols or sounds. One example of such a variation is displaying the cue in a different color to differentiate from other objects or images displayed. In some embodiments, the cue may appear to have a different characteristic, different color, symbol, sound or other feature than other objects, images, sounds presented in the task. The subject may be instructed to perform a specific task in response to being presented a cue. In some embodiments, the subject may be instructed to push a button or click on an image or symbol in a computer displayed user interface in response to the presence of a specified cue. An example may include displaying a group of objects that are the same color and instructing the subject to push a button when an object of a different color is displayed, then displaying a group of objects all having the same color except for one more that are displayed in a different color. In some embodiments the subject may be instructed to recall an order of events that occurred during the task. An example includes displaying a series of objects to the subject where a number of the objects change color, then instructing the subject to recall the objects that changed color in a specific order (the same order as it appeared or backwards). In some embodiments, positive reinforcement may be provided to the subject in response to completion of a task. In some such embodiments, positive reinforcement may include encouraging statements or in the form of points or other value within the context of a game.

In some embodiments, the subject's responses or results from the task may be stored in a database. The results of the task may be organized in a database to form a profile of the subject. The profile of the subject may include information about the subject's age or other demographic information that would allow the profiles of a plurality of subjects to be categorized. In some embodiments, where the systems and methods for targeted strengthening of brain networks for fluent reading acquisition may be implemented in a school, the profiles of subjects may be grouped by grade, age, class or other characteristic.

In some embodiments, the task may be scored. The task may be scored on a numerical scale. A database of responses to the various assessment tasks may be generated using previous results from the subject or other subjects with a range of reading fluencies and neuronal connectivities between working memory network areas of the brain. The database may associate fluency in reading and neuronal connectivity with a range of scores for the assessment tasks. In some embodiments, a profile of the subject is generated through the results of the task. The subject's performance in a task may be scored and compared to a database of scores and responses. The subject's scores may be correlated with relative strength of the neuronal connectivity of the working memory network areas of the brain. In some embodiments scores may be correlated with neuronal connectivity by comparing the subject's score in a task to scores in the database.

Referring back to FIG. 5, weaknesses in the neuronal connectivity of the working memory network areas of the subject's brain may be identified (step 504) by comparing the score of the assessment task to a database of scores. In some other embodiments identifying weaknesses may include comparing the subject's responses to the task to the responses of one or more other subjects. In some embodiments, identifying weaknesses may include comparing the subject's responses to the task to one or more models of responses. Identifying weaknesses can include comparing the subject's responses to the task to a set of known responses that may be associated with different connectivities. In some embodiments, weaknesses in the neuronal connectivity of the working memory network areas of the subject's brain may be identified by comparison of scores to a model of scores that correlates neuronal connectivity. In some such embodiments a model may be generated by fitting a function to observed trends of white matter volume, observed anisotropy of diffusion in neurons or other measurement of structural characteristic of neurons in relation to scores. Such functions that may be used as part of a model of scores are depicted in FIG. 1B.

Selecting a training exercise (step 506) may include selecting a training exercise that targets remediation of the areas of the brain, or connectivities thereof, where weaknesses were identified. In some embodiments, selecting a training exercise (step 506) can include retrieving a training exercise from a computer-readable memory. Selecting a training exercise (step 506) may include selecting a combination or group of training exercises. Training exercises may be categorized by the areas of the brain that they strengthen neuronal connectivity of. A training exercise may be selected (step 506) based on the area of the brain that the training exercise is categorized to strengthen neuronal connectivity of and where weakness was identified (step 504). In some embodiments, selecting a training exercise (step 506) may be automated and performed by an electronic computing device. In some of these embodiments, the task may be selected (step 506) by a personal computing device such as a home computer, a smartphone, an electronic multimedia device, or a tablet computing device, such as the IPAD (manufactured by Apple, Inc. of Cupertino, Calif.) or the MICROSOFT SURFACE (manufactured by Microsoft Corporation or Seattle, Wash.). In other embodiments, the task may be selected (step 506) via electronic gaming console.

In some embodiments, the training exercise may be delivered (step 508) as a game or in the context of a game. The training exercise may be delivered (step 508) via an electronic computing device. In some embodiments, the training exercise may be delivered (step 508) via a personal computing device such as a home computer, a smartphone, an electronic multimedia device, or a tablet computing device, such as the IPAD (manufactured by Apple, Inc. of Cupertino, Calif.) or the MICROSOFT SURFACE (manufactured by Microsoft Corporation or Seattle, Wash.). In other embodiments, the training exercise may be delivered (step 508) via electronic gaming console. In some embodiments, the training exercise may be delivered (step 508) in series with other training exercises. In some embodiments, delivering the training exercise (step 508) may include delivering a combination or group of training exercises.

In some embodiments, the training exercise may target a single area, multiple areas, short term stores, or connectivity between multiple areas. In some embodiments, the training exercise may require the subject to recall or react to cues like symbols, letters, sounds or 2-dimensional locations. The training exercise may combine types of cues like sounds, shapes, symbols or locations with each other. The training exercise may require the subject to associate certain cues with others. The training exercise may be directed toward training the subject's ability to perceptually categorize stimuli that have been presented to them. The training exercise may also train the subject's reaction time. In some embodiments, the training exercise may require the subject to push a button upon receiving a specified stimulus. The stimulus, in this case, may be any above-described cue or combination thereof. The training exercise may be grid-based to specify locations in a 2-dimensional space. In some embodiments, the training exercise may be a symbol-digit coding exercise, in which the subject is prompted to observe and react to one or more patterns of digits. In some embodiments, spatial distribution of stimuli is not achieved through display on a grid alone but may also feature moving stimuli or specifically ordered stimuli. Training exercises may be presented in the same format as some assessment tasks. In some embodiments, training exercises may target cognitive processes that are associated with strengthening connectivities in specific areas of the brain, such as verbal short-term memory, verbal working memory, processing speed, executive function, psychomotor speed, sustained attention and cognitive flexibility. Training exercises may deliver a stimulus for which frequency of presentation, duration and number of stimuli may be systematically increased. Training exercises may be multi-modal, strengthening neuronal connectivity in multiple areas of the brain by combining cognitive processes that they target.

In some embodiments, training exercises may be delivered (step 508) to strengthen neuronal connectivity in areas of the brain that are associated with specific cognitive processes. Some examples of such cognitive processes include verbal-short-term memory, verbal working memory, processing speed, executive function, psychomotor speed, response time, sustained attention, cognitive flexibility and reasoning.

Training exercises may be generated by determining tasks that improve cognitive processes specifically associated with neuronal connectivities of areas of the brain involved in the working memory network.

In some implementations, positive reinforcement may be delivered to the subject upon completion of a training exercise. Positive reinforcement may be delivered in the form of encouraging statements or in the form of points or other value within the context of a game.

1. A computer-based system for targeted strengthening of brain networks for fluent reading acquisition system comprising:
retrieving by one or more processors a task from a memory element;
delivering by one or more processors the task to assess neuronal connectivity of working-memory-network areas of a brain of a subject;
receiving by one or more processors responses to the task from the subject;
converting by one or more processors the responses into a score;
identifying by one or more processors weaknesses in neuronal connectivity between working-memory-network areas of the brain based on the score;
selecting by one or more processors a training exercise based on the identified weaknesses;
retrieving by one or more processors the training exercise from a memory element; and
delivering by one or more processors the training exercise to increase neuronal connectivity in working-memory-network areas of the brain of the subject with the identified weaknesses.

2. The system of claim 1, wherein the one or more processors store the score in a memory element.

3. The system of claim 2, wherein storing the score further comprises storing the score in a database of responses and scores.

4. The system of claim 1, further comprising:
a user interface for delivering the task.

5. The system of claim 1, further comprising:
a user interface for delivering the exercise.

6. The system of claim 1, further comprising:
a transmitter in electrical communication with a network.

7. The system of claim 1, wherein converting the responses to a score further comprises comparing the responses to a model of responses.

8. A method for targeted strengthening of brain networks for fluent reading acquisition comprising:
delivering a task to a subject to assess neuronal connectivity of working-memory-network areas of a brain of the subject;
identifying weaknesses in the neuronal connectivity between working-memory-network areas of the brain based on the assessment;
selecting a training exercise based on the identified weaknesses; and
delivering the training exercise to the subject to increase neuronal connectivity between the identified working-memory-network areas.

9. The method of claim 8, wherein delivering a task further comprises delivering a game.

10. The method of claim 8, wherein delivering a task further comprises delivering the task via an electronic computing device.

11. The method of claim 8, wherein identifying weaknesses further comprises identifying weaknesses in neuronal connectivity of verbal areas of a brain of the subject.

12. The method of claim 8, wherein identifying weaknesses further comprises identifying weaknesses in neuronal connectivity of visual areas of a brain of the subject.

13. The method of claim 8, wherein identifying weaknesses further comprises identifying weaknesses in neuronal connectivity of visuo-spatial areas of a brain of the subject.

14. The method of claim 8, wherein selecting a training exercise further comprises selecting a training exercise that increases neuronal connectivity of verbal areas of a brain of the subject.

15. The method of claim 8, wherein selecting a training exercise further comprises selecting a training exercise that increases neuronal connectivity of visual areas of a brain of the subject.

16. The method of claim 8, wherein selecting a training exercise further comprises selecting a training exercise that increases neuronal connectivity of visuo-spatial areas of a brain of the subject.

17. The method of claim 8, further comprising:
delivering positive reinforcement to the subject upon completion of the task.

18. The method of claim 8, further comprising:
delivering positive reinforcement to the subject upon completion of the training exercise.

19. The method of claim 8, further comprising:
storing results of the task in a database.

20. The method of claim 8, further comprising:
re-delivering a task to a subject to assess neuronal connectivity of working-memory-network areas of a brain of the subject;
identifying weaknesses in the neuronal connectivity between working-memory-network areas of the brain based on the re-assessment;
selecting a training exercise based on the identified weaknesses; and
delivering the training exercise to the subject to increase neuronal connectivity between the identified working-memory-network areas.
